(19) United States
(12) Patent Application Publication
(10) Pub. No.: US 2020/0218459 A1
(43) Pub. Date: Jul. 9, 2020

(54) MEMORY-MAPPED STORAGE I/O

(71) Applicant: NEC Laboratories Europe GmbH, Heidelberg (DE)

(72) Inventor: Simon Kuenzer, Heidelberg (DE)

(21) Appl. No.: 16/646,155

(22) PCT Filed: Sep. 13, 2017
(86) PCT No.: PCT/EP2017/073047

§ 371 Date: Mar. 11, 2020

(51) Int. Cl. G06F 3/06

(52) U.S. Cl. CPC G06F 3/0623; G06F 3/0619; G06F 3/064; G06F 3/0673; G06F 3/0664; G06F 3/0653; G06F 3/0665

(57) ABSTRACT

A method for performing memory-mapped storage I/O includes by a first computing system, providing storage containing memory pages accessible to at least one second computing system. The at least one second computing system includes a memory region representing a virtual block device that is managed by the first computing system in such a way that the first computing system is enabled to map memory pages of its storage to the virtual block device, to keep memory pages of its storage unmapped or to protect memory pages of its storage for certain kinds of access. The method includes by the at least one second computing system, performing I/O operations by accessing a memory page of the virtual block device and by reading or modifying the content of the memory page.

### CROSS-REFERENCE TO RELATED APPLICATIONS

This application is a U.S. National Phase Application under 35 U.S.C. § 371 of International Application No. PCT/EP2017/073047, filed on Sep. 13, 2017. The International Application was published in English on Mar. 21, 2019 as WO 2019/052643 under PCT Article 21(2) and is hereby incorporated by reference herein.

### FIELD

The present invention relates to a method and a system for performing memory-mapped storage I/O.

### BACKGROUND

Today, memory-mapped storage I/O (e.g. POSIX mmap) is a widely deployed access method that maps memory pages (which generally contain a file or a file-like resource) to a region of memory. Generally, the performance of storage devices has a direct impact on the performance of memory-mapped storage I/O in the sense that it can be expected that better storage devices will lead to better performance.

### SUMMARY

In an embodiment, the present invention provides a method for performing memory-mapped storage I/O. The method includes by a first computing system, providing storage containing memory pages accessible to at least one second computing system. The at least one second computing system includes a memory region representing a virtual block device that is managed by the first computing system in such a way that the first computing system is enabled to map memory pages of its storage to the virtual block device, to keep memory pages of its storage unmapped or to protect memory pages of its storage for certain kinds of access. The method includes by the at least one second computing system, performing I/O operations by accessing a memory page of the virtual block device and by reading or modifying the content of the memory page.

The method includes in case of attempting, by the at least one second computing system, to access an unmapped memory page or a memory page protected for the kind of access, offloading the I/O handling for such memory page from the at least one second computing system to a backend component of the first computing system that analyzes a status of the respective memory page and, depending on the status, initiates measures for getting the respective memory page mapped to the virtual block device of the at least one second computing system.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 is a schematic view illustrating a system for performing memory-mapped storage I/O in a virtualized environment in accordance with an embodiment of the present invention;

FIG. 2 is a schematic view illustrating a system for performing memory-mapped storage I/O in an environment including a non-type-1 hypervisor or a regular OS in accordance with an embodiment of the present invention; and

FIG. 3 is a schematic view illustrating a system for performing memory-mapped storage I/O in an environment including a type-1 hypervisor or a microkernel in accordance with an embodiment of the present invention.

### DETAILED DESCRIPTION

Recent fast storage technologies that appeared on the markets and that natively utilize a memory-map storage interaction model achieve high performance since I/O operations (e.g., read, write) are performed by simply accessing a mapped memory address by the software, thereby eliminating the overhead for setting up requests for these operations (as it is done with traditional storage device, such as hard disk drives). Recent persistent memory modules, so called non-volatile RAM (NVRAM), or persistent RAM are even directly interconnected with the system's memory controller, i.e. avoiding the I/O bus (e.g., PCI Express) where a storage controller is conventionally attached (e.g., via SAS, SATA, SCSI) and that communicates with the actual storage device, which even shortens the physical communication path between the central processing unit and the persistent storage unit. Generally, such devices are targeted to provide fastest storage performance, i.e. with little overhead (and correspondingly low delay) and high throughput, where in contrast traditional storage technologies (e.g., hard disk drives) focus on high data density and reduced investments costs per Byte.

Since traditional storage systems perform I/O asynchronously by setting up requests and waiting for the respective storage device to respond, separate storage stacks exist today. In case of machine virtualization, the storage interface models are usually forwarded to the guest with the implication that utilizing different storage technologies is non-transparent to the guest. In particular, migrating between the technologies involves making the guest aware (non-transparent). In order to achieve transparency for the guest, existing solutions implement a unified interface that always uses the request-response model (independent of underlying hardware storage technology). However, high performance is then not achieved anymore. Conversely, i.e. in case of not using the request-response model, but the memory-mapped model (synchronous I/O) as unified interface, whenever traditional storage (asynchronous I/O) is used for this, the complete guest would be blocked until I/O operations are completed.

In view of the above an embodiment of the present invention provides a method and a system for performing memory-mapped storage I/O in such a way that the above issues are overcome or at least partially alleviated.

In accordance with an embodiment of the invention, a method for performing memory-mapped storage I/O is provided, the method comprising:
by a first computing system, providing storage containing memory pages accessible to at least one second computing system, wherein said at least one second computing system includes a memory region representing a virtual block device that is managed by said first computing system in such a way that said first computing system is enabled to map memory pages of its storage to said virtual block device, to keep memory pages of its storage unmapped or to protect memory pages of its storage for certain kinds of access,
by said at least one second computing system, performing I/O operations by accessing a memory page of said virtual block device and by reading or modifying the content of said memory page,
in case of attempting, by said at least one second computing system, to access an unmapped memory page or a memory page protected for the kind of access, offloading the I/O handling for such memory page from said at least one second computing system to a backend component of said first computing system that analyzes a status of the respective memory page and, depending on the status, initiates measures for getting the respective memory page mapped to said virtual block device of said at least one second computing system.

Furthermore, in an embodiment, a system for performing memory-mapped storage I/O is provided, comprising:
a first computing system and at least one second computing system,
wherein said first computing system is configured to provide storage containing memory pages accessible to said at least one second computing system,
wherein said at least one second computing system includes a memory region representing a virtual block device that is managed by said first computing system in such a way that said first computing system is enabled to map memory pages of its storage to said virtual block device, to keep memory pages of its storage unmapped or to protect memory pages of its storage for certain kinds of access,
wherein said at least one second computing system is configured to perform I/O operations by accessing a memory page of said virtual block device and by reading or modifying the content of said memory page, and
wherein said first computing system includes a backend component that is configured to perform the I/O handling for memory pages accessed by said at least one second computing system that are not yet mapped to said virtual block device or that are protected for the kind of access, wherein said backend component is configured to analyze the status of the respective memory page and, depending on the status, to initiate measures for getting the respective memory page mapped to said virtual block device of said at least one second computing system.

According to an embodiment of the invention it has been recognized that, even when utilizing different storage technologies in a way transparent to the second computing system, high performance memory-mapped storage I/O can be achieved by offloading the actual I/O handling to a backend component of the first computing system (e.g. a hypervisor or a driver domain).

To this end, embodiments of the invention make use of a virtual storage interface that is used for providing a generic interface to the second computing system, e.g. guest virtual machines, while supporting native I/O performance of the underlying storage technology, i.e. this generic interface is also a unified interface in the sense that it is used for both, traditional and modern, (in particular) persistent storage types. This is in contrast to prior art solutions where memory-mapped interfaces (e.g., POSIX mmap( ) are public domain knowledge and where signaling for reporting status is always implemented as asynchronous signaling (e.g., Unix signals).

In contrast to the present invention, related state-of-the-art work focus on emulating (via mmap( )and without asynchronous calls) or passing through non-volatile RAM to guests (for reference, see for instance http://www.linux-kvm.org/images/d/dd/03x10A-Xiao_Guangrong-NVDIMM_Virtualization.pdf, or https://lists.xen.org/archives/html/xen-devel/2016-08/msg00606.html). In particular, however, the interface is not intended to be used as a generic interface for request-response storage.

The method and the system according to an embodiment of the present invention have the advantage that offloading actual I/O handling to a backend component of the first computing system, e.g. hypervisor or driver domain, enables hiding of storage driver internals from the second computing system, e.g. guest. The I/O type is transparent to guests, i.e. both traditional storage and NVDIMMs are supported, which significantly simplifies migrating between them. Even mixed-type storage types are supported, which may be implemented, for instance, for placing file system meta data on NVRAM and data on traditional storage. Furthermore, the driver in the second computing system can be implemented as a simple and lean drive, since reading/writing of memory pages in a system according to an embodiment of the present invention is always as simple as just accessing a memory address. This is particularly beneficial for implementing micro-services based on small kernels (e.g., Unikernels).

Another problem which is targeted by embodiments of the present invention rises in the situation when the same request-response storage is used by multiple guests. Currently, each of the guests will perform I/O by setting up requests and operating on self-owned and organized cache buffers. According to embodiments of the invention also caching can be offloaded to the backend driver unit. Loaded buffers are just mapped to guests which (1) avoid nested request setup and (2) enable data deduplication in the system. In particular, in case of traditional I/O, block buffer caches can be handled in a hypervisor/driver domain (i.e. in the first computing system), which makes implicit data deduplication possible when multiple guests use the same storage. As a result, efficiency of the used memory pages is increased.

According to an embodiment it may be provided that in case a status analysis reveals that a respective memory page is already loaded or mapped, respectively, from a storage device and is available in the first computing system, the backend component directly establishes a mapping of the memory page to the virtual block device.

According to an embodiment it may be provided that in case a status analysis reveals that a respective memory page has not yet been mapped from a map-able storage device and is not available in the first computing system, the backend component instructs a corresponding storage driver to map the memory page from a map-able storage device that has the memory page.

In both of the cases described above it may be provided that an execution flow of a task processed by the second computing system that was interrupted because of an unsuccessful attempt of this second computing system to access a memory page is continued at the point of interruption after the respective memory page is mapped to the virtual block device.

According to an embodiment it may be provided that, in case a status analysis reveals that a respective memory page is not yet loaded from a request-response storage device into a buffer page of the first computing system and is not available in the first computing system, the backend component instructs a corresponding storage driver to transmit a read request for this memory page to a request-response storage device that has this memory page.

In this case it may be provided that the backend component informs the second computing system by means of a first notification that an execution flow interruption experienced by this second computing system is due to an unsuccessful attempt to access a memory page and that I/O handling for such memory page is currently under operation and has to be finished before the execution flow can be continued. In order to enable the second computing system to perform proper mapping or assignment of such notifications to specific execution flow interruption events, it may be provided that the first notification includes a unique identifier, which may be generated by the backend component.

According to an embodiment the backend component, after finishing I/O handling by mapping the respective memory page to the virtual block device of the second computing system, may inform the second computing system accordingly by means of a second notification, which may carry the same unique identifier that was already contained in the corresponding first notification.

According to an embodiment, upon receiving a first notification, the second computing system may block a task currently under execution. If another different task is ready for execution, the second computing system may start executing this different task. Alternatively, particularly if no other task is currently ready for execution, the second computing system may just wait until the corresponding second notification is received. In any case, the second computing system may, in reaction to the second notification, unblock the blocked task and continue its execution.

According to an embodiment the first computing system may comprise one or more storage drivers that are configured to instruct both a request-response storage device and a map-able storage device to load or map a respective memory page to the first computing system's storage.

According to an embodiment the system may comprise an interface between the first computing system and the at least one second computing system, wherein this interface may be configured as a unified storage interface that supports signaling mechanisms both for loading memory pages from request-response storage devices and for mapping memory pages from map-able storage devices.

According to an embodiment the first computing system may include a virtual machine monitor and the at least one second computing system may be a virtual machine of this virtual machine monitor.

According to an embodiment the first computing system may include a driver domain and the at least one second computing system may be a guest domain machine that interacts with this driver domain for storage I/O.

According to an embodiment the first computing system may include an operating system kernel and the at least one second computing system may include an application running under this operating system kernel.

According to an embodiment the first computing system may include a driver application and the at least one second computing system may be another application that interacts with this driver application for storage I/O.

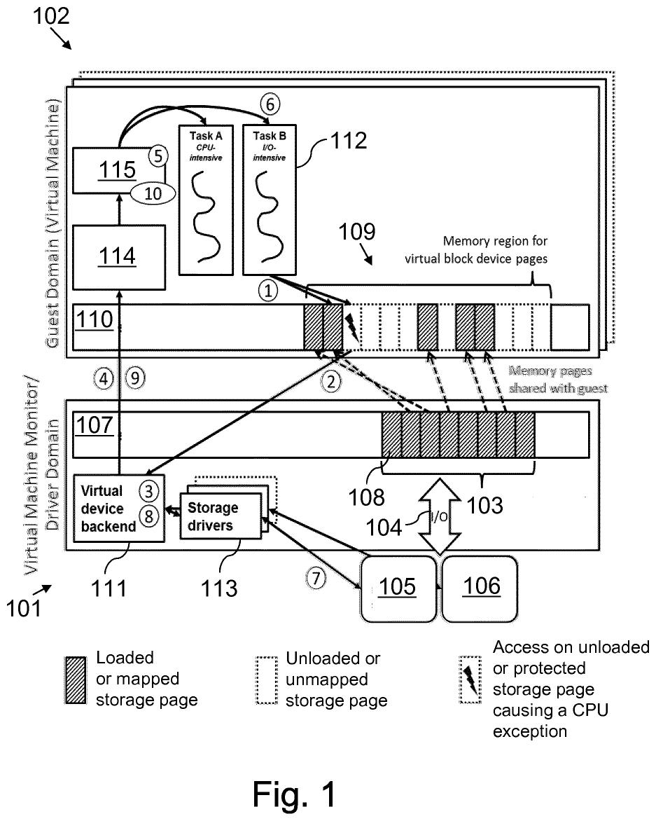

FIG. 1 schematically illustrates a system for performing memory-mapped storage I/O in accordance with an embodiment of the present invention. The system is localized in a virtualized environment and includes, as a first computing system, a virtual machine monitor VMM 101, sometimes also referred to as hypervisor, that creates and runs (as at least one second computing system) a number of virtual machines 102, one of which being depicted in greater detail in FIG. 1. In this scenario, the term ‘driver domain’ will sometimes be used as a synonymous term for the virtual machine monitor, while the term ‘guest domain’ may synonymously refer to the running virtual machine.

The VMM 101 includes storage 103 that is either directly attached or that is reached through networking. This storage 103 provides either a request-response interface 104 to a request-response storage device 105, or can be mapped from a map-able storage device 106, or both. Thus, the storage 103, which is organized in an address space 107 of the VMM 101, can include memory pages 108 either in form of storage cache pages or in form of mapped storage pages.

The guest domain 102 does I/O by accessing a memory region representing a virtual block device 109. This memory region, organized in an address space 110 of the guest domain 102, is provided and managed by a backend unit part 111, i.e. virtual device backend, of the VMM 101 or driver domain. Specifically, the backend unit part 111 can map memory pages 108 of the VMM's 101 storage 103 to the virtual block device 109, can keep memory pages 108 of the VMM's 101 storage 103 unmapped or can protect memory pages 108 of the VMM's 101 storage 103 for certain kinds of access. Therefore, depending on the current situation, when the guest domain 102 accesses a memory page 108 of this region, this memory page 108 might be mapped, mapped but protected for the respective kind of access (e.g., read, write), or unmapped.

According to a general definition, a memory-mapped page 108 or file is a segment of virtual memory (i.e. virtual block device 109) which has been assigned a direct byte-for-byte correlation with some portion of a file or file-like resource. Once present, this correlation between the file (which may be directly contained in the respective device's 101 storage 103 or may be reached through networking) and the memory space permits the guest domain 102 to treat the mapped portion as if it were primary memory.

The guest domain 102 includes a number of task units 112 (e.g., threads, programs, or the like). While the embodiment generally applies to any number of tasks, for the sake of simplicity FIG. 1 only depicts two of them exemplarily: task ‘A’ that is assumed to be CPU intensive, and task ‘B’ that is assumed to be I/O intensive. In the illustrated scenario it is assumed that task ‘B’ in the guest domain 102 is doing I/O by accessing the memory region for the virtual block device 109, as indicated at step (1).

Accessing an unmapped memory page 108 or a memory page 108 protected for the kind of access (e.g., write) causes the guest execution flow of task ‘B’ to be interrupted, since resources required for executing the task 112 are unavailable. Furthermore, as shown at step (2), it causes the virtual device backend 111 to be activated. The virtual device backend 111 analyzes the particular reasons for the failure, which may be one of the following:

The according memory page 108 is already loaded/mapped and available in the VMM/driver domain 101 but not mapped to the guest domain 102 yet.

The according memory page 108 is not available in the VMM/driver domain 101, e.g. because the storage was not yet loaded into a buffer page from a request-response storage device 105 or is not yet ready for mapping from a map-able storage device 106.

The memory page 108 was mapped but protected for the type of access (e.g., read, write).

Depending on the specific reason analyzed at step (2), the virtual device backend 111 initiates, indicated at (3), appropriate measures for getting the respective memory page 108 mapped to the virtual block device 109 of the guest domain 102.

For instance, in case of above-mentioned reason a), the virtual device backend 111 may directly establish a mapping for the requested memory page 108. Afterwards, i.e. once the respective memory page 108 is mapped to the virtual block device 109 at the guests domain 102, the virtual device backend 111, by means of an appropriate signaling mechanism, may let the guest 102 continue its execution flow of task ‘B’ at the point of interruption. Since in this case the reason for the guest domain's 102 failed I/O access can be solved directly by the backend 111, the guest domain 102 is not informed, i.e. the process is virtually transparent to the guest domain 102 (apart from an experienced interruption of the execution flow for a minimum duration).

In case of above-mentioned reason b), the virtual device backend 111 may start initiating the corresponding storage device 105, 106 to prepare the memory page 108 for mapping. For this purpose, the corresponding storage driver 113 is utilized by the backend 111 to instruct the storage device 105, 106. In case of request-response storage, a read request is setup. In case of map-able storage, the corresponding memory page of the device is mapped. Only if the respective operation can be fulfilled directly and does not require a delayed reply from the storage device 105, 106 the virtual device backend 111 will let the guest domain 102 continue its task 112 execution directly afterwards and will not inform the guest domain 102 about this operation. Typically, this will be the case for mapping from map-able storage 106. In contrast, loading a memory page 108 from a request-response storage device 105 involves a delay. The respective actions performed by the virtual device backend 111 in this case will be described in detail further below, starting with step (4) of FIG. 1.

In case of above-mentioned reason c), the virtual device backend 111 may initiate appropriate measures depending on the kind of protection (e.g., (a)synchronous write-through, copy-on-write, sync) selected for the respective memory page 108. For instance, it might instruct the corresponding storage device 105, 106 to perform a corresponding action (e.g., write). A possible corresponding change to mapping (e.g., in case of copy-on-write) could be also performed. If the operation does not require the guest 102 to stop its execution flow, the guest 102 will continue its execution flow at the point of interruption as soon as the virtual driver backend 111 finished its work. Otherwise, the process will continue with step (4). Here, it should be noted that it is possible that the backend 111 removes another mapping to fulfill the listed job.

Turning now to step (4), the backend 111 informs the guest domain's 102 virtual device driver 114, by transmitting a respective first notification, that the guest's 102 task 112 execution flow got interrupted due to a failed or unsuccessful I/O access. This notification may also include the information that the backend 111 is currently performing operations to enable proper I/O access to the respective memory page 108 and that these operations have to be finished before the guest's 102 task 112 execution flow can be continued. Still further, the backend 111 may generate a unique identifier that is also passed to the guest 102 together with the notification. For instance, this identifier may include a monotonic increasing number, or the respective memory page's 108 virtual block device 109 address.

As indicated at (5), if the guest domain 102 has a task unit scheduler 115, the virtual device driver 114 is informing this scheduler 115 that the current scheduled task unit 112, i.e. task ‘B’ in the illustrated embodiment, has to be blocked because it has to wait for an I/O event. As indicated at (6), the scheduler 115 marks the current task unit 112 as blocked and schedules a different task unit 112 that is ready for execution (e.g. task ‘A’ in the illustrated embodiment). Otherwise, i.e. if the guest domain 102 does not have a task unit scheduler 115, the guest 102 may yield from its execution, or may execute some other instructions, e.g. task ‘A’.

In any case, as indicated at (7), as soon as the respective storage device 105, 106 finished its operation, it informs the storage driver 113 which notifies the virtual device backend 111 about the status. As indicated at (8), if the device status was successful, the virtual device backend 111 will finish the request by mapping the corresponding memory page 108 to the guest domain's 102 virtual block device 109. In error cases, no mapping will happen.

As indicated at (9), the virtual driver backend 111 informs the virtual device driver 114 that the operation has been finished, i.e. that the respective memory page 108 is mapped to the guest 102. By transmitting a second notification, the virtual driver backend 111 sends the status code of the operation to the guest 102. This second notification may also include the previously generated unique identifier. With the help of this unique identifier, the guest's 102 virtual device driver 114 is enabled to relate the first and the second notification to each other, i.e. the virtual device driver 114 knows that both notifications relate to one and the same event of unsuccessful I/O access.

Finally, as indicated at (10), if the guest 102 has a task unit scheduler 115 and the operation was successful, the virtual device driver 111 informs this scheduler 115 that the affected task unit 112 can be unblocked and can continue its execution. If no scheduler 115 is available the guest 102 can continue its execution. In case of error, an appropriate error routine may be called. As will be easily appreciated by those skilled in the art, a common implementation many forward the error status to the task unit 112 for handling.

As will be appreciated by those skilled in the art, embodiments of the present invention and, in particular, the operational scheme described above in connection with the embodiment of FIG. 1, are not bound to a single guest 102 and single backend 111. In this regard it is noted that one backend 111 can serve multiple virtual storage devices 109 to non-exclusively multiple guests, as indicated in FIG. 1 by the further frames depicted underneath guest domain 102. Furthermore, multiple backends 111 can exist on a single computer system 101. A single backend 111 could even handle multiple storage devices 105, 106.

Furthermore, it is noted that if the guest 102 is able to create further memory address spaces (nested paging), it is able to forward mappings of the virtual block device region (e.g., mmap( ) for guest userspace, execution in=place in the guest, nested virtualization).

In principle, the present invention is not bound to virtualization. It is also applicable for various types of OSes where a guest is equivalent to an application having its own address space (e.g., user space) and another application or the OS kernel performing the driver backend work.

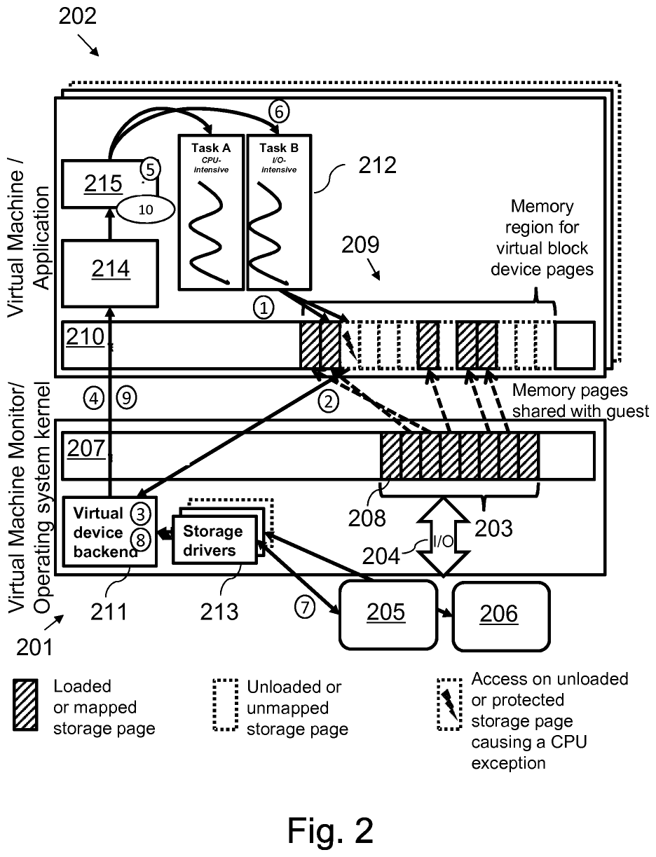

In accordance with an embodiment of the present invention, FIG. 2 is a schematic view illustrating a system for performing memory-mapped storage I/O in an environment including a non-type-1 hypervisor or a regular OS kernel 201, constituting the first computing system, and an application 202 running under the operating system kernel 201, constituting the second computing system. In this system, the operational scheme described in connection with FIG. 1 could be implemented in a similar way.

In a comparable manner as in the embodiment of FIG. 1 (like method steps are denoted by like reference numbers), in the embodiment of FIG. 2 the application 202 can access storage 203 provided by the hypervisor 201 through a shared memory-based interface. As shown in FIG. 2, virtual storage appears as contiguous region in the application's 202 physical address space 207, organized in pages 208. For an I/O operation (e.g., read, write), the application 202 just accesses one of these memory pages 208 and reads or modifies its content.

The storage region 209 is provided by a backend driver unit 212 of the hypervisor 201, which may be part of the virtualization software: either as part of a virtual machine monitor (VMM) or separate guest that interacts with the storage device in its native model (also called driver domain). The backend 212 is able to keep some memory pages 208 unmapped in this region or protect them for certain kinds of accesses.

It is assumed that the application's 202 CPU will raise an exception/interrupt that stops a current instruction flow whenever an illegal access to a memory page 208 of the virtual storage device 209 happened. In such a case a handler is called in the backend unit 211 that executes an according algorithm, i.e. in accordance with the embodiments described above in connection with FIG. 1, depending on the selected behavior for the respective memory page 208. The backend unit 211 might instruct the corresponding storage device 205, 206 to perform a corresponding action (e.g., requesting writing the content of the memory page 208 to the persistent storage).

Whenever it is valid that the application 202 can continue its task 212 execution after the algorithm is executed, the backend driver 211 will not inform the application 202 and let it continue executing the respective task 212. In the other cases, the application 202 is notified and thus able to execute some other work that is ready for execution (instead of getting just blocked, as it would be with a pure memory-map solution).

For this purpose, embodiments of the invention introduce a signal mechanism from backend driver 211 to the application 202, which can be implemented by software interrupts or some other sort of application signaling. This signal invokes a handler in the application 202, which is then able to instruct stop executing the current task 212 and maybe start executing another task 212. Another signal is introduced whenever the first computing device's operation of mapping the respective memory page 208 to the application's 202 virtual block device 209 is finished. In this case the signal informs the application 202 that the original task can continue processing. On the other hand, in case of errors, e.g. when the first computing device's backend 211 fails, for whatever reason, to map the respective memory page 208 to the application's 202 virtual block device 209, the signal informs the application 202 that it should run an error handling routine.

Whenever the handler of the backend 211 is executed, it is able to change the mapping or protection of every memory page 208 belonging to virtual storage regions. Memory pages 208 from a memory-mapped storage 206 are forwarded by mapping them to the application's 202 address space 207. In case of request-response storage, memory pages 208 are standard RAM memory pages and belong to the driver backend unit 211. They are used as buffer caches for the I/O requests. The virtual storage 203 does not have to be mapped completely to the application 202. This enables, for instance, to restrict the number of required buffer cache pages.

Applying both to the embodiment of FIGS. 1 and 2, an interface may be introduced where the guest 102 or the application 202, respectively, can send some hints to the backend 111, 211 in order for optimizations (e.g., keeping pages containing meta data always available to speed up lookups). However, there might be no guarantee that the backend 111, 211 is fulfilling all the hints.

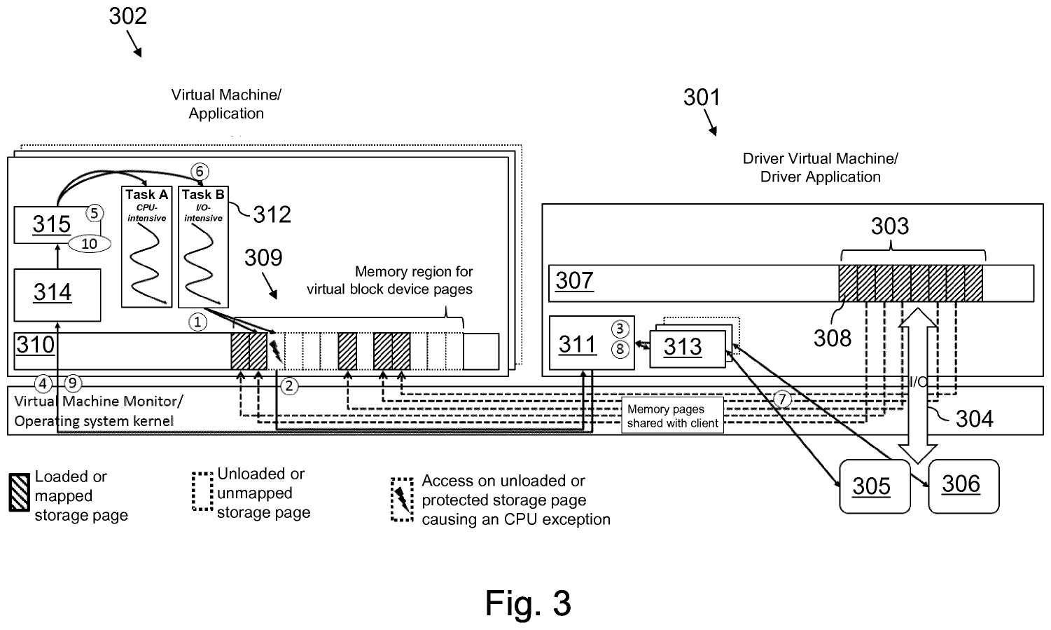

FIG. 3 is a schematic view illustrating, in accordance with an embodiment of the present invention, a system for performing memory-mapped storage I/O in an environment including, as the first computing system, a type-1 hypervisor or a microkernel managing a driver application 301, and, as the second computing system, another application, hereinafter denoted interacting application 302, that interacts with the driver application 301 for storage I/O.

The principles of operation are basically the same as in FIGS. 1 and 2 and like method steps are denoted by like reference numbers. The driver application 301 has storage 303 directly attached or reaches it through networking. This storage 303 provides either a request-response interface or can be memory-mapped or both. The interacting application 302 does I/O by accessing a memory region representing a virtual block device 309. This memory region is provided and managed by a backend unit part 311 of the driver application 301.

Depending on the current situation when the interacting application 302 accesses a memory page 308 of the memory region that represents the virtual book device 309, this memory page 308 might be mapped, mapped and protected for this kind of access (e.g., read, write), or unmapped. If the memory page 308 is mapped and not protected for the kind of access, it is either a forwarded page from a memory mapped storage device 306 or a buffer page that the backend 311 uses for interacting with a request-response storage device 305. Accessing an unmapped memory page 308 or a memory page 308 protected for the respective kind of access causes the backend 311 of the driver application 301 to become active, and task execution at the interacting application 302 is interrupted.

The backend 311 of the driver application 301 performs an according action and returns to the interacting application 302 directly when it is able to process the respective memory page 308 and to make it directly available for the interacting application 302, e.g. by establishing a new mapping or by removing an existing protection. On the other hand, in case the backend 311 has to set up an error or an I/O request, the interacting application 302 is notified that its current execution flow cannot be continued. By virtue of this notification, the interacting application 302 is then able to schedule a different execution unit (task or thread) or to release the CPU. As soon as the I/O request is done, the backend 311 establishes a new mapping, or removes the protection from the respective memory page 308. Then, it informs the interacting application 302 that the accessed memory page 308 is ready now so that the interacting application 302 can continue the execution of the original task unit 312.

Finally, it should be noted that any of the tasks 312 can either be a (sub)process each having an own address space (especially in the Virtual Machine cases) or a thread operating on the same address space of the application/virtual machine (in the application case or when the Virtual Machine uses just a flat single address space (e.g., Unikernel) or when the thread is part of the guest operating system kernel (kernel thread)).

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for performing memory-mapped storage I/O, the method comprising:
by a first computing system, providing storage containing memory pages accessible to at least one second computing system, wherein the at least one second computing system includes a memory region representing a virtual block device that is managed by the first computing system in such a way that the first computing system is enabled to map memory pages of its storage to the virtual block device, to keep memory pages of its storage unmapped or to protect memory pages of its storage for certain kinds of access,
by the at least one second computing system, performing I/O operations by accessing a memory page of the virtual block device and by reading or modifying the content of the memory page,
in case of attempting, by the at least one second computing system, to access an unmapped memory page or a memory page protected for the kind of access, offloading the I/O handling for such memory page from the at least one second computing system to a backend component of the first computing system that analyzes a status of the respective memory page ) and, depending on the status, initiates measures for getting the respective memory page mapped to the virtual block device of the at least one second computing system.

2. The method according to claim 1, wherein, in case a status analysis reveals that a respective memory page is already loaded/mapped from a storage device and is available in the first computing system, the backend component establishes a mapping of the memory page to the virtual block device.

3. The method according to claim 1, wherein, in case a status analysis reveals that a respective memory page has not yet been mapped from a map-able storage device and is not available in the first computing system, the backend component instructs a corresponding storage driver to map the memory page from a map-able storage device having the memory page.

4. The method according to claim 2, wherein an execution flow of a task processed by the at least one second computing system that was interrupted owing to an unsuccessful attempt to access a memory page is continued at the point of interruption after the respective memory page is mapped to the virtual block device.

5. The method according to claim 1, wherein, in case a status analysis reveals that a respective memory page is not yet loaded from a request-response storage device into a buffer page of the first computing system and is not available in the first computing system, the backend component instructs a corresponding storage driver to transmit a read request for the memory page to a request-response storage device having the memory page.

6. The method according to claim 5, wherein the backend component informs the at least one second computing system by means of a first notification that an execution flow interruption experienced by the at least one second computing system is due to an unsuccessful attempt to access a memory page and that I/O handling for such memory page (108; 208; 308) is currently under operation and has to be finished before the execution flow can be continued.

7. The method according to claim 6, wherein the first notification includes a unique identifier generated by the backend component.

8. The method according to claim 7, wherein the backend component, after finishing I/O handling by mapping the respective memory page to the virtual block device of the at least one second computing system, informs the at least one second computing system accordingly by means of a second notification including the unique identifier.

9. The method according to claim 8, wherein the at least one second computing system, in reaction to the first notification, blocks a task currently under execution and starts executing a different task, and wherein the at least one second computing system, in reaction to the second notification, unblocks the blocked task and continues its execution.

10. A system for performing memory-mapped storage I/O, the system comprising:
a first computing system and at least one second computing system,
wherein the first computing system is configured to provide storage containing memory pages accessible to the at least one second computing system,
wherein the at least one second computing system includes a memory region representing a virtual block device that is managed by the first computing system in such a way that the first computing system is enabled to map memory pages of its storage to the virtual block device, to keep memory pages of its storage unmapped or to protect memory pages of its storage for certain kinds of access,
wherein the at least one second computing system is configured to perform I/O operations by accessing a memory page of the virtual block device and by reading or modifying the content of the memory page, and wherein the first computing system includes a backend component that is configured to perform the I/O handling for memory pages accessed by the at least one second computing system that are not yet mapped to the virtual block device or that are protected for the kind of access, wherein the backend component is configured to analyze the status of the respective memory page and, depending on the status, to initiate measures for getting the respective memory page mapped to the virtual block device of the at least one second computing system.

11. The system according to claim 10, wherein the first computing system comprises one or more storage drivers that are configured to instruct both a request-response storage device and a map-able storage device to load or map a respective memory page to the first computing system's storage.

12. The system according to claim 10, comprising an interface between the first computing system and the at least one second computing system, the interface being configured as a unified storage interface that supports signaling mechanisms both for loading memory pages from request-response storage devices and for mapping memory pages from map-able storage devices.

13. The system according to claim 10, wherein the first computing system includes a virtual machine monitor and wherein the at least one second computing system is a virtual machine the virtual machine monitor.

14. The system according to claim 10, wherein the first computing system includes a driver domain and wherein the at least one second computing system is a guest domain machine that interacts with the driver domain for storage I/O.

15. The system according to claim 10, wherein the first computing system includes an operating system kernel and wherein the at least one second computing system includes an application running under the operating system kernel, or
wherein the first computing system includes a driver application and wherein the at least one second computing system is another application that interacts with the driver application for storage I/O.
